(19) United States
(12) Patent Application Publication
(10) Pub. No.: US 2020/0130558 A1
(43) Pub. Date: Apr. 30, 2020

(54) ALL-TERRAIN VEHICLE TRANSPORTATION AND RECOVERY DEVICE

(71) Applicant: BRYAN VERHULP, ARNPRIOR (CA)

(72) Inventor: BRYAN VERHULP, ARNPRIOR (CA)

(21) Appl. No.: 16/662,463

(22) Filed: Oct. 24, 2019

Related U.S. Application Data
(60) Provisional application No. 62/749,753, filed on Oct. 24, 2018.

(51) Int. Cl. B60P 3/07; B62D 53/04; B62D 63/06

(52) U.S. Cl. CPC B60P 3/07; B62D 63/062; B62D 53/045

(57) ABSTRACT

Off-road incidents, breakdowns etc. require that an all-terrain vehicle (ATV) is recovered. Typically, the environments these incidents occur prevent driving pick-up trucks etc. to them to use conventional trailers. Similarly, prior art mounts for towing an ATV require its placement and attachment which can be extremely difficult during warmer months when caked in mud, leaves, etc. and worse in winter when caked in snow, ice, etc. Accordingly, it would be beneficial to provide users with a means of transporting an ATV within off-road environments allowing not only a simple and easy assembly/attachment of the ATV with the ATV transportation means but also for the resulting combination of the towing vehicle, in all likelihood another ATV, and the ATV transportation means to be driven out of the off-road environment to an on-road environment for subsequent repair, transportation etc. of the broken or other ATV.

### CROSS-REFERENCE TO RELATED APPLICATIONS

This application claims the benefit of priority from U.S. Provisional Patent Application 62/749,753 filed Oct. 24, 2018 entitled “All-Terrain Vehicle Transportation and Recovery Device”, the entire contents of which are herein incorporated by reference.

### FIELD OF THE INVENTION

This patent application relates to a device for loading and towing all-terrain vehicles and more particularly to recovering all-terrain vehicles off road.

### BACKGROUND OF THE INVENTION

Various types of all-terrain vehicles (ATVs) have become popular in recent years and include both three, four and six-wheeled models with variants for one, two and four seats. Referring to FIG. 1A examples of these are quad-bike 100A, one-seater ATV 100B, two-seater ATV 100C, two-seater side-by-side ATV 100D, four-seater ATV 100E and six-wheeler ATC 100F. Whilst these are very useful vehicles and intended to be reliable breakdowns occur. Further other incidents can arise due to the nature of the terrain they are driven on, for example, or as the result of accidents. In these situations, the ATV is typically off-terrain and far removed from any road or recovery point using prior art recovery vehicles such as tow-trucks, low loaders, etc. This leaves the owner with the problem of transporting and recovering a broken down or damaged ATV from some remote location off-road.

Within the prior art one method of transporting ATVs conveniently is to load them on the back of a pickup truck such as through the use of ramps or by actually lifting the entire vehicle itself, which requires the assistance of several individuals. However, off-road incidents, breakdowns etc. prevent driving the pick-up truck into the off-road environment the ATV is broken down within. Alternatively, there are various types of hauling trailers available for transporting one or more ATV/ATC's which can be towed by another vehicle, provided with a suitable hitch mechanism, and generally include their own support wheels and suspension systems. The vast majority of these still require the entire ATV to be placed on the trailer and no part of the ATV remains in contact with the ground.

Referring to U.S. Pat. No. 4,592,564 to Warnock et al. entitled “ATV/ATC Two Bar” an alternate tow device is described of which two design variants are depicted in FIG. 1B in first and second images 100G and 100H respectively. Warnock describes a bar having an attachment mechanism for removably securing the bar to the ATV frame and a hitch assembly for removably connecting the tow bar to a car or truck ball hitch or any other type of conventional towing hinge. In first image 100G a design for a four-wheel ATV the ATV is attached to the bar at points near or on both of its front and rear axles. Alternatively, in second image 100H the design for a three-wheel ATV is depicted the ATV is attached at a point near or on its rear axle and small frame assembly supports the front wheel of the three-wheel ATV.

However, placing the bar, detaching the mounting elements, and re-attaching them to the bar once placed in association with the ATV may be extremely difficult for the ATV user or another individual as the ATV during warmer months may be caked in mud, leaves, etc. and within winter months caked in snow, ice, etc. Accordingly, accessing the underneath of the ATV to attach the rear attachment means of Warnock may be difficult or impossible if that is the portion of the ATV that has sustained damage. Further, lifting and positioning the front of the ATV may itself be difficult in of itself even before consideration of attaching the bar to the ATV.

Accordingly, it would be beneficial to provide users with a means of transporting an ATV within off-road environments allowing not only a simple and easy assembly/attachment of the ATV with the ATV transportation means but also for the resulting combination of the towing vehicle, in all likelihood another ATV, and the ATV transportation means to be driven out of the off-road environment to an on-road environment for subsequent repair, transportation etc. of the broken or other ATV. Accordingly, the ATV transportation means should allow for the resulting combination of the ATV and ATV transportation means to be traverse off-road environments, go over obstacles, etc.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to device for loading and towing all-terrain vehicles and more particularly to recovering all-terrain vehicles off road.

In accordance with an embodiment of the invention there is provided a device comprising:

a lower frame portion;

an upper frame portion mechanically coupled to the lower frame and rotatable relative to the lower portion;

at least a pair of wheels attached to the lower frame;

a linking bar at least one of rigidly attached and demountably attached to the lower frame at one end with a first coupling and having a second coupling at the other distal end for demountably attaching the device to a vehicle for towing the device.

In accordance with an embodiment of the invention there is provided a method comprising:

providing a transportation device for moving a first vehicle with a second vehicle;

positioning the transportation device adjacent to a pair of wheels of the first vehicle;

disposing the transportation device in a vertical position with an upper frame of the transportation device adjacent to the pair of wheels of the first vehicle and a linking bar the transportation device pointing substantially perpendicular and upwards relative to the terrain upon which the pair of wheels of the first vehicle are disposed;

attaching the pair of wheels of the first vehicle to the upper frame of the transportation device; transitioning the transportation device from this vertical position to a horizontal position by using the linking bar as a mechanical lever thereby lifting the pair of wheels of the first vehicle off the ground such that they are supported on the upper platform of the transportation device.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts prior art all-terrain vehicles (ATVs) which may be transported using an ATV transportation device (ATV-TD) according to embodiments of the invention;

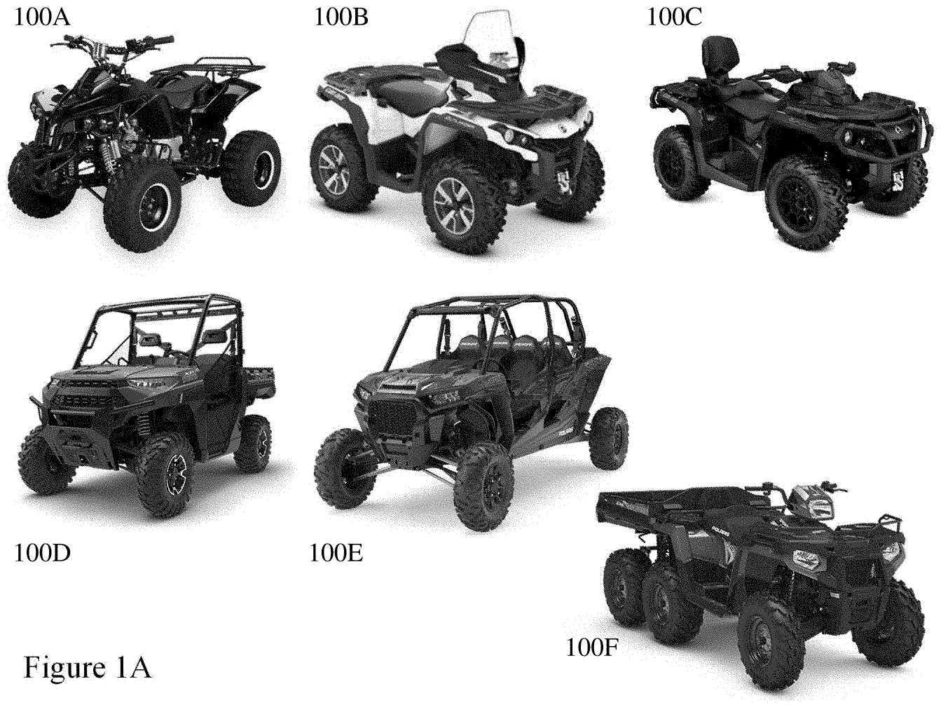

FIG. 1B depicts a prior art solution according to U.S. Pat. No. 4,592,564;

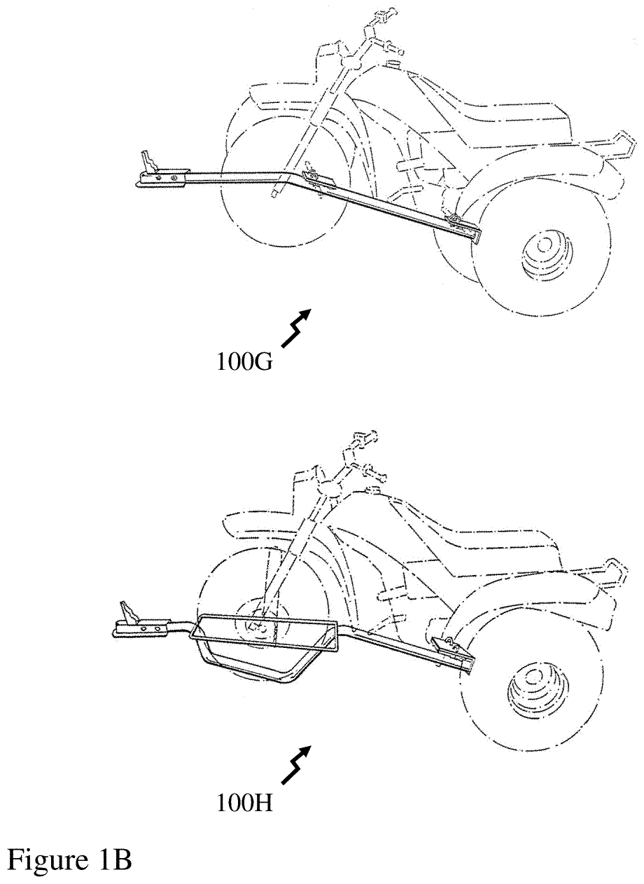

FIG. 2 depicts images of an ATV-TD according to embodiments of the invention;

FIG. 3 depicts images of an ATV-TD according to embodiments of the invention with ATV attached to demonstrate maneuverability and support means;

FIG. 4 depicts images of an ATV-TD according to embodiments of the invention with ATV attached indicating the linking bar;

FIG. 5 depicts images of an ATV-TD according to embodiments of the invention within an off-road environment to indicate easy mounting of the ATV to the ATV-TD;

FIG. 6 depicts images of an ATV-TD according to embodiments of the invention with ATC attached; and

FIG. 7 depicts schematic images of a linkage mechanism for an ATV-TD according to an embodiment of the invention.

### DETAILED DESCRIPTION

The present invention is directed to device for loading and towing all-terrain vehicles and more particularly to recovering all-terrain vehicles off road.

The ensuing description provides representative embodiment(s) only, and is not intended to limit the scope, applicability or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers or groups thereof and that the terms are not to be construed as specifying components, features, steps or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

A “fitting” as used herein and throughout this disclosure, refers to any machine component, piping or tubing part that can attach or connect two or more parts. Such fittings may include, but not be limited to, a coupling, couplings, compression fitting, pipe fitting, piping fittings, plumbing fittings, and plumbing fitting.

A “mounting” as used herein and throughout this disclosure, refers to part of a device, system., ancillary, etc. which is configured to support and/or attach another device, system, ancillary, components etc. to said part of the device, system, ancillary, component etc. A mounting typically supports demountable attachment of the parts but may be employed in permanent attachment to define the location of the point of attachment or support demountable attachment prior to permanent attachment.

A “fixing” or “attachment means” as used herein and throughout this disclosure, refers to component, device, or means employed to permanently or demountably attach a device, system, ancillary, components etc. to part of another device, system, ancillary, component etc. This may include, but not be limited to, depending upon whether permanent or demountable and the material(s) being joined fasteners, glues, resins, epoxies, cementing, welding, soldering, brazing, pressure differentials, magnets, clamps, clips, ties, supports, physical retention elements such as clips and crimps, and physical retention methods such as friction and interference fit. Fasteners may include, but not be limited to, bolts, nuts, washers, screws, threaded fasteners, rivets, nails, pins, hook-and-eye, and hook and loop.

A “demountable” connection as used herein and throughout this disclosure, refers to component, device, or means employed to permanently or demountably attach a mechanical connection, an electrical connection or fluidic connection on a device, system, ancillary, components etc. to another mechanical connection, electrical connection or fluidic connection on another device, system, ancillary, component etc. A demountable connection may be a solely mechanical connection. A demountable electrical or fluidic connection may include a mechanical connection to ensure the requisite electrical or fluidic connection is maintained.

A “user” as used herein may refer to, but is not limited to, an individual or group of individuals. This includes, but is not limited to, private individuals, employees of organizations and/or enterprises, members of community organizations, members of charity organizations, men and women. In its broadest sense the user may further include, but not be limited to, robotic systems, android systems, etc. that may be characterised by an ability to exploit one or more embodiments of the invention.

An “all-terrain vehicle” (ATV), also known as a quad, quad bike, three-wheeler, four-wheeler or quadricycle as defined by the American National Standards Institute (ANSI) is a vehicle that travels on, typically, low-pressure tires, and is designed to handle a wider variety of terrain than most other vehicles. An ATV may in some jurisdictions being street-legal. Whilst, using the current ANSI definition, ATVs are intended for use by a single operator, some ATVs are intended for use by an operator and one passenger. However, within this specification an ATV may also include, three or four-wheel recreational utility vehicles (RUVs) wherein rather than the operating sitting on and operating the ATV like a motorcycle, they sit in a seat and employ a steering wheel like a car rather than handlebars. Whilst most ATVs are equipped with three or four wheels, six-wheel models exist for specialized applications.

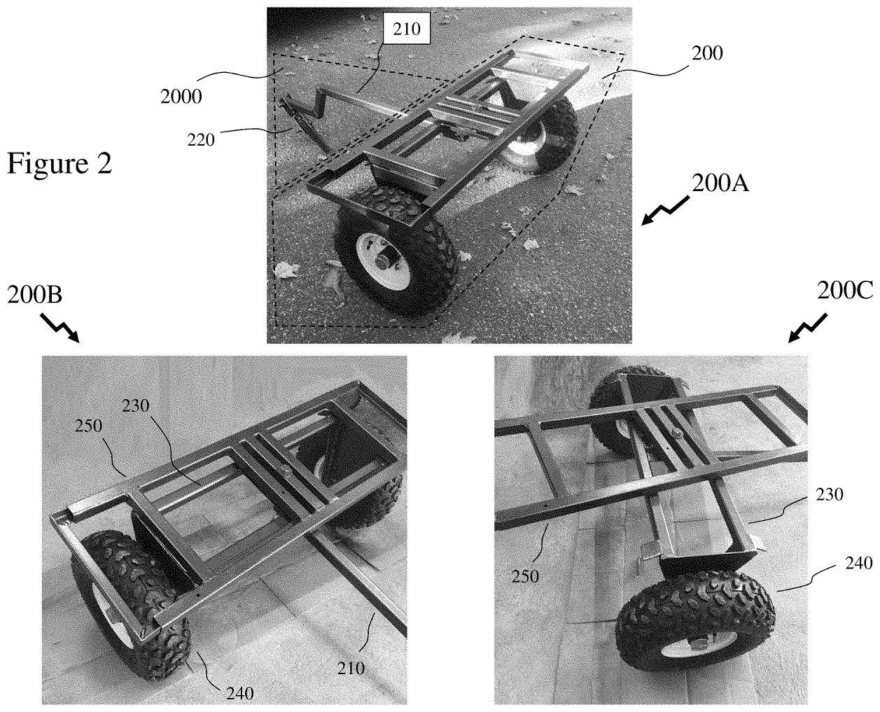

Referring to FIG. 2 depicted first to third images 200A to 200C respectively of an ATV-TD according to embodiments of the invention. These being:
First image 200A which is a rear perspective view of the ATV-TD according to an embodiment of the invention;
Second image 200B which a front perspective view of the ATV-TD according to an embodiment of the invention; and
Third image 200C which is a side perspective view of the ATV-TD according to an embodiment of the invention.

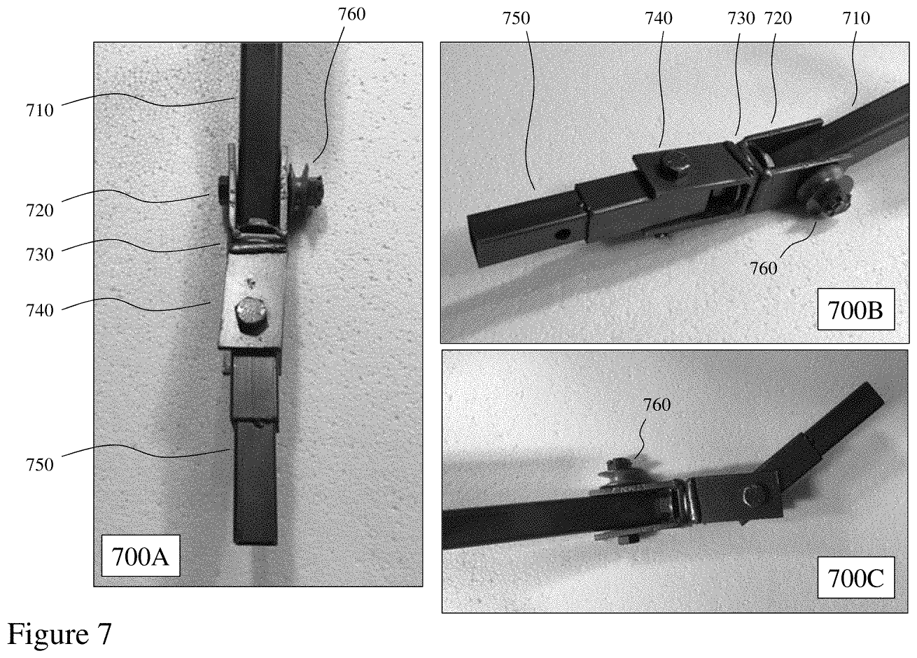

The ATV-TD as depicted comprises a transport and mounting portion (TAMP) 200 and a connection portion (CONP) 2000. The CONP 2000 of the ATV-TD links the TAMP 200 assembly with the alternate vehicle (not depicted for clarity) which will pull the ATV-TD with or without the broken/damaged ATV attached. As depicted the CONP 2000 consists of a strut 210 having a predetermined geometry and is coupled to the TAMP 200 at one end and has a coupling assembly 220 at the other distal end from the TAMP 200 for coupling to a towing means on the alternate vehicle. The coupling assembly 220 being described and depicted in more detail below with respect to FIG. 7.

This towing means may be a tube hitch, such as a 1.25″ (32 mm) tube hitch or 2″ tube (50 mm) tube hitch for example, which comprises a hollow tube (receiver tube) on one element into which another tube (on the other element) slides and is retained with a coupling means such as a lock pin or cotter pin for example. The tubes may be of any cross-section geometry, but the common formats are circular and square. Typically, the portion on the rear of an ATV comprises a receiver tube and hence typically the distal end of the CONP 2000 for such coupling means would comprise the other tube which fits into the receiver tube. The ATV-TD may support the use of an adapter to convert, for example, a 2″ hitch to a 1.25″ hitch or vice-versa.

Alternatively, the towing means may be a ball hitch wherein a ball mount is attached, typically, to the vehicle which will tow, and the portion being towed has a hitch coupler comprising a housing which fits over the ball of the ball mount. In some ball hitches additional locking or retention means may be employed. Optionally, chains may be also employed in conjunction with a hitch between the ATV-TD and ATV to prevent a failure or uncoupling of the hitch resulting in the ATV-TD being left behind. It would be evident that the ATV-TD may support the use of an adapter to convert a tube hitch end of the CONP 2000 to mount to a ball hitch or vice-versa. As will also be evident from the description in respect of FIG. 7 other means of connecting the CONP 2000 to the towing vehicle may be employed beyond the ball hitch and tube hitch as may different means of attaching the CONP 2000 to the TAMP 200. It would be evident that other means of attaching the CONP 2000 to the towing vehicle and the CONP 2000 to the TAMP 200 may be employed other than those described and depicted within the Figures and described within the specification without departing from the scope of the invention.

The TAMP 200 comprises a chassis having a lower frame 230 to which a pair of wheels 240 are attached. An upper frame 250 of the TAMP 200 is attached to the lower frame 230 of the TAMP 200 which can rotate relative to the lower frame as evident from the different positions of the upper frame 250 to the lower frame 230 in second and third images 200B and 200C in FIG. 2. At each end of the upper frame 250 are slidable frame portions 260 which can be moved relative to the upper frame 250 such that the slidable frame portions 260 can be adjusted to ensure the wheels of the ATV being transported fit upon it. Optionally, the slidable frame portions 260 may include additional sliding elements which couple to the upper frame 250 so that the front wheels of the ATV being mounted/transported do not drop down onto the wheels 240 of the TAMP 200. Optionally the slidable frame portions 260 may be locked into one of a plurality of positions through techniques known in the art such as pins, bolts etc. through holes within each of the upper frame 250 and slidable frame portions 260.

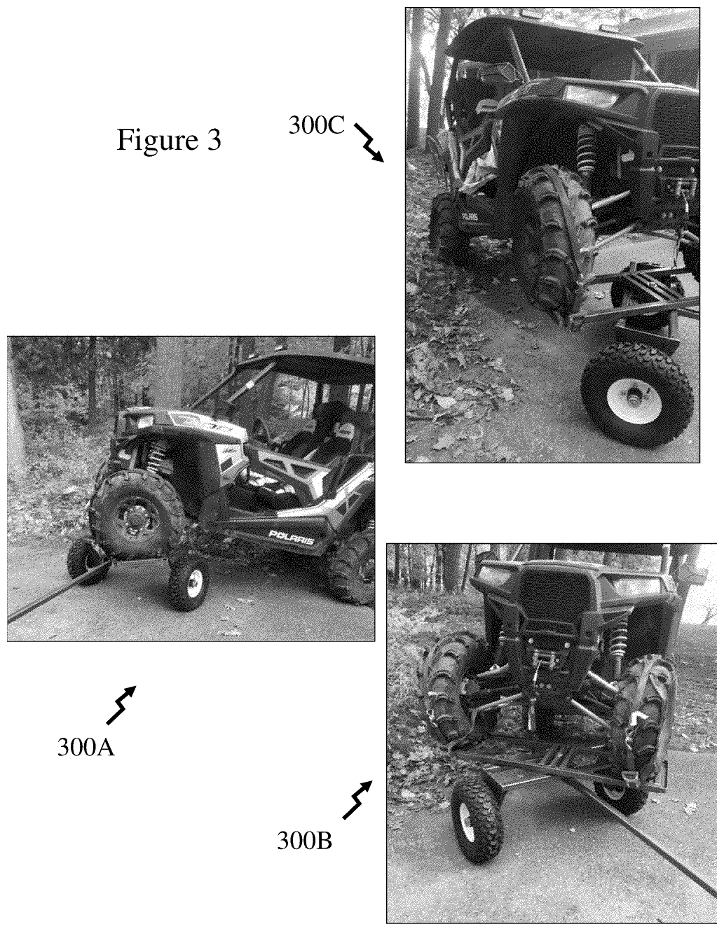

Referring to FIG. 3 depicted first to third images 300A to 300C respectively of an ATV-TD according to embodiments of the invention with ATV attached to demonstrate maneuverability and support means. These being:
First image 300A with an ATV mounted onto the ATV-TD according to an embodiment of the invention with the ATV-TD lower frame rotated relative to the upper frame;
Second image 300B with an ATV mounted onto the ATV-TD according to an embodiment of the invention with the ATV-TD lower frame rotated relative to the upper frame; and
Third image 300C with an ATV mounted onto the ATV-TD according to an embodiment of the invention with the ATV-TD lower frame rotated relative to the upper frame.

Accordingly, it is evident from first to third images 300A to 300C respectively that the front (or rear) of an ATV mounts to the upper frame of the ATV-TD and that the lower portion of the ATV-TD can rotate relative to the upper frame allowing for a tight turning circle for the ATV-TD which is beneficial either when being towed, in positioning the ATV-TD to mount the ATV prior to its being towed or in positioning the ATV-TD to park or dismount the ATV after its being towed. As depicted in FIG. 2 in first to third images 200A to 200C the pivot point of the upper frame 250 of the TAMP portion of the ATV-TD is at the middle of the upper frame 250 and accordingly is approximately directly below the lifted and mounted axle of the ATV being recovered and/or towed.

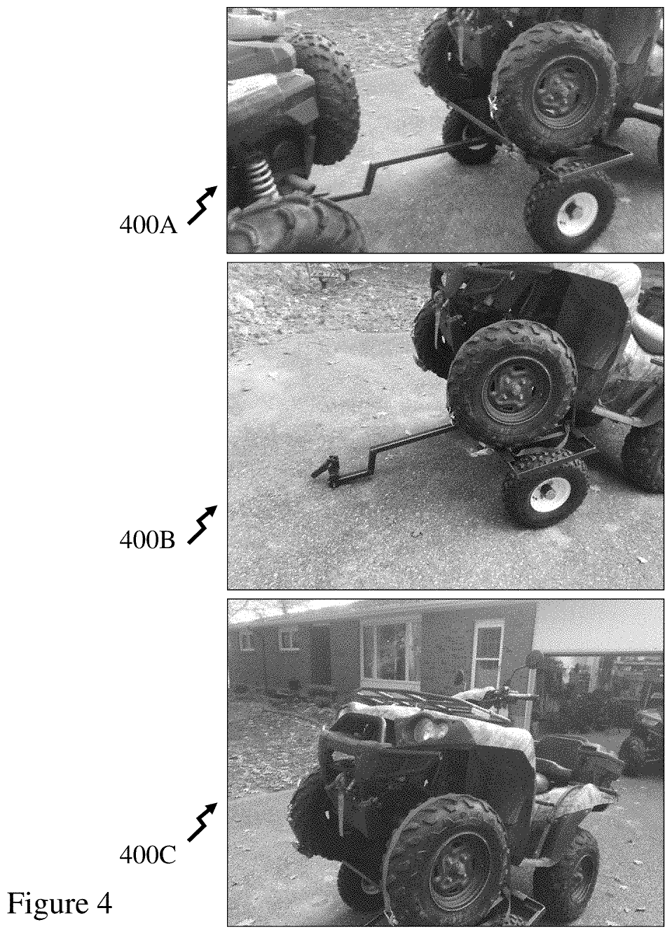

Referring to FIG. 4 depicted first to third images 400A to 400C respectively of an ATV-TD according to embodiments of the invention with ATV attached indicating the linking bar. These being:
First image 400A with the ATV-TD according to an embodiment of the invention with mounted ATV attached to a towing ATV;
Second image 400B with the ATV-TD according to an embodiment of the invention with mounted ATV but not attached to any towing ATV; and
Third image 400C with the ATV attached to the ATV-TD according to an embodiment of the invention.

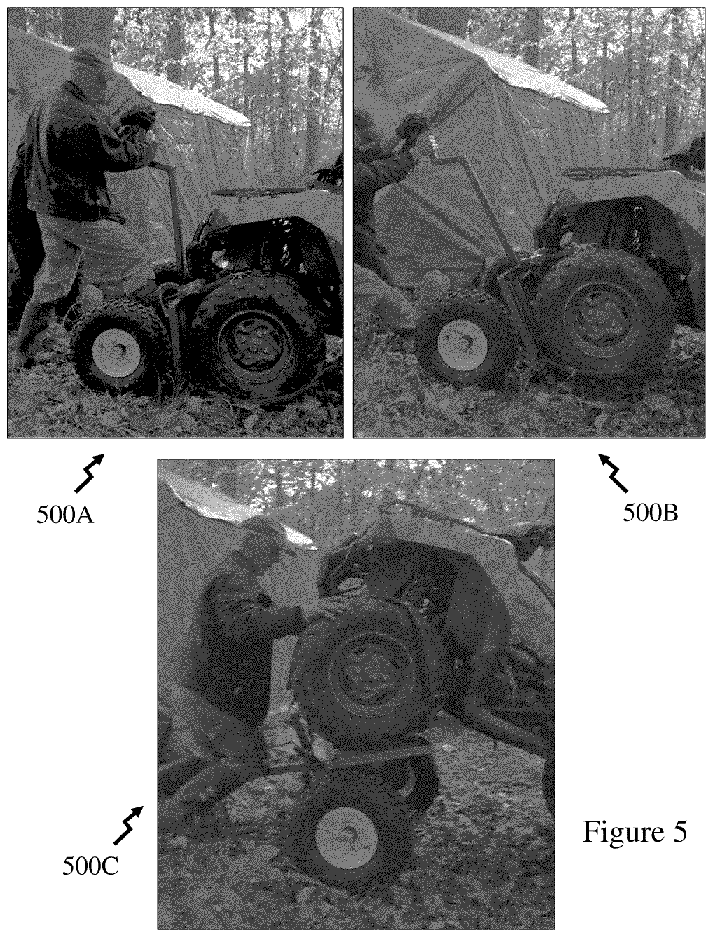

Accordingly, as evident in first to third images 400A to 400C in FIG. 4 as well as first to third images 300A to 300C in FIG. 3 the wheels of the ATV sit upon the upper frame of the ATV-TD thereby allowing the upper frame to be compatible with mounting the front wheel of a three-wheel ATV, the front pair of wheels of a four-wheel ATV, the rear pair of wheels of a four-wheel ATV, etc. As will become evident from the ensuing description in respect of FIG. 5 and first to third images 500A to 500C respectively these restraints are attached when the ATV-TD is employed in lifting one of the ATV's axle off the ground. As depicted the wheels of the ATV are attached with restraints, actually ratchet tie down straps which allow for their attachment with relative ease and simplicity irrespective of environmental factors such as rain, snow, wind, etc. and those of the environment the ATV is within or has been through such as mud, brush, snow, etc. Optionally, the restraints may be discrete from the ATV-TD or they may be attached to the ATV-TD such that they do not get lost etc. Ratchet tie-downs allow for a range of wheel diameters to be accommodated on the ATV-TD. Alternatively, other means of restraint may be employed, including but not limited to, cam buckle tie downs, cam buckle tie-downs with hook(s), rubber straps with hooks, lashing straps, tie straps, tire straps and bungee straps.

Referring to FIG. 5 depicted first to third images 500A to 500C respectively of an ATV-TD according to embodiments of the invention within an off-road environment to indicate easy mounting of the ATV to the ATV-TD. These being:
First image 500A wherein the ATV-TD according to an embodiment of the invention has been detached from the vehicle towing it and rotated to a vertical position against the wheels of the other ATV to be recovered;
Second image 500B wherein the user is pulling down the linking bar and pushing it so that the wheel of the ATV being recovered are lifted off the ground and the ATV-TD according to an embodiment of the invention is rotating back towards its original orientation; and
Third image 500C wherein the “lifting process” has been completed and the front wheels of the ATV being recovered are not on top of the upper platform of the ATV-TD according to an embodiment of the invention.

Accordingly, the process for achieving position of the wheel of the vehicle being recovered for an ATV-TD according to an embodiment of the invention comprises the following sequence:
Step 1: Tow the ATV-TD to the vehicle being recovered;
Step 2: Unhitch the ATV-TD;
Step 3: Position the ATV-TD in front of the wheels of the vehicle being recovered;
Step 4: Rotate the ATV-TD from its initial essentially horizontal position to a vertical position;
Step 5: Attach the wheels to the upper platform of the ATV-TD with restraints and tighten;
Step 6: Start to pull the linking bar of the ATV-TD down and push the ATV-TD TAMP forward towards the vehicle being recovered; and
Step 7: Complete pulling the linking bar of the ATV-TD down and pushing ATV-TD TAMP forwards until the wheels of the vehicle being recovered are on top of the upper frame of the ATV-TD TAMP.

Accordingly, the placement of the vehicle being recovered can be performed with a single individual although commonly the driver of the vehicle being recovered will also be present as well as the driver of the vehicle recovering them. Alternatively, where the vehicle being recovered is light the wheel(s) to be raised of the floor can be lifted and the ATV-TV TAMP positioned appropriately and then the restraints done up. An unloading sequence may comprise essentially the reverse sequence wherein the ATV-TD with ATV attached is transitioned from its horizontal position to the vertical position and the restraints removed allowing the ATV-TD to be separated from the ATV.

Optionally, the vehicle to which the ATV-TD will be attached when towing an ATV may comprise a winch or pulley thereby allowing the ATV to be transported and/or recovered to be winched up onto the ATV-TD or to pull the linking bar down within steps 6 and 7 of the sequence described above in respect of loading the ATV to be towed and/or recovered onto the ATV-TD. This may be particularly beneficial for the instance of a single individual towing and/or recovering an ATV and loading the ATV on their own but can be employed even where two or more individuals are present for the loading/unloading. Alternatively, the pulley or winch may form part of the vehicle being towed and/or recovered. A pulley wheel as depicted in first to third images 700A to 700C on the distal end of the linking bar from the TAMP portion of the ATV-TD may be employed to aid in the winching/pulley operations.

However, within other embodiments of the invention a pulley or winch may form part of the ATV-TD or provide a mounting point for a pulley or winch to be attached. This pulley or winch when attached to the ATV-TD may be powered by either the ATV to provide the towing and/or recovered or the ATV being towed and/or recovered or alternatively it may be a manually operated pulley or winch. A pulley wheel as depicted in first to third images 700A to 700C on the distal end of the linking bar from the TAMP portion of the ATV-TD may be employed to aid in the winching/pulley operations. The pulley/winch may be disposed upon the linking bar, particularly in instances where the linking bar is an A-frame design or equivalent, or it may be formed as part of the upper frame or lower frame of the TAMP portion of the ATV-TD.

Optionally, the upper frame of the ATV-TD may be adjustable to support narrow or wide ATVs.

Optionally, lower frame may also be adjustable to increase or decrease the wheel spacing.

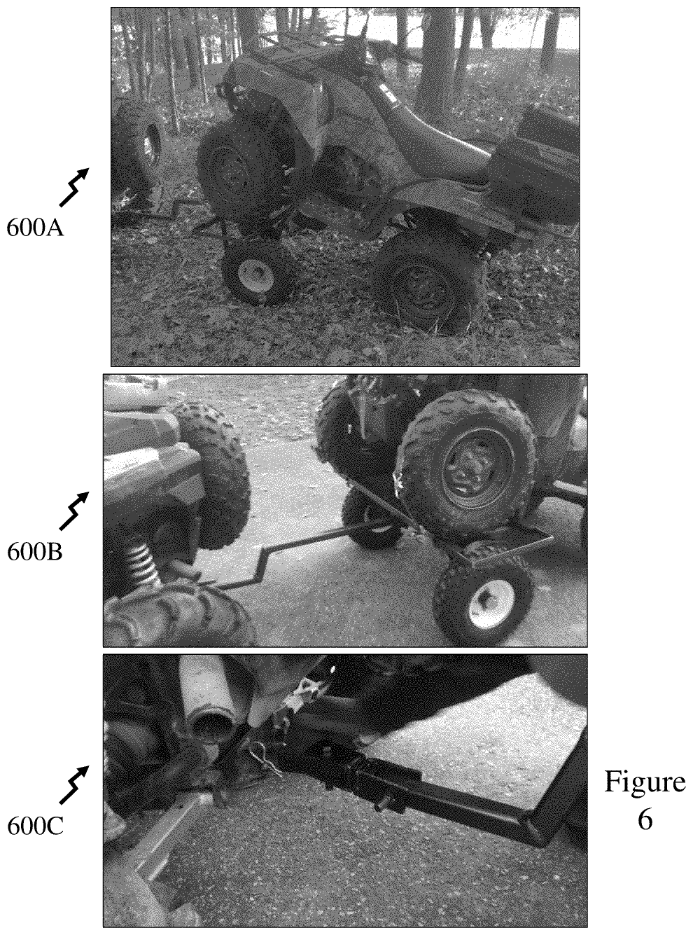

Referring to FIG. 6 depicted first to third images 600A to 600C respectively of an ATV-TD according to embodiments of the invention with ATC attached. These being:
First image 600A depicting the ATV-TD according to an embodiment of the invention with an ATV mounted and attached being towed;
Second image 600B depicting the front wheels of an ATV upon the upper frame of the ATV-TD TAMP of an ATV-TD according to an embodiment of the invention; and
Third image 600C depicting the attachment of the linking bar of an ATV-TD according to an embodiment of the invention to an ATV towing hitch, the hitch being a tube hitch.

Now referring to FIG. 7 there are depicted first to third images 700A to 700C of the distal end of the CONP, for example CONP 200 in FIG. 2, of the ATV-TD links the TAMP assembly, see for example TAMP 200 in FIG. 2, of the ATV-TD according to an embodiment of the invention which attaches to the hitch on the vehicle which will tow the ATV-TD according to an embodiment of the invention. This distal end, for example the coupling assembly 220 as depicted in FIG. 2, comprising:
Linking bar 710, e.g. strut 210 in FIG. 2;
First joint 720 which allows relative motion in a plane substantially perpendicular to the terrain (vertical pivot);
Second joint 730 which allows rotation motion of the ATV-TD relative to the vehicle towing it relative to the longitudinal axis of the linking bar 710;
Third joint 740 which allows rotation between the ATV-TD and the vehicle towing it in a plane substantially parallel to the terrain (horizontal pivot);
Tube hitch 750; and
Pulley wheel 760.

Within first image 700A the distal end of the linking bar 710 of the ATV-TD according to an embodiment of the invention is depicted from above with the first joint 720 rotated such that the second and third joints 730 and 740 together with tube hitch 750 are titled up away from the ground. Second image 700B depicting this same configuration but from a front upper perspective. Third image 700C depicts the distal end of the linking bar 710 of the ATV-TD according to an embodiment of the invention with the third joint 740 rotated. The pulley wheel 760 may be employed as described above in conjunction with a winch or pulley to move and/or tilt-rotate the ATV-TD when loading/unloading the ATV being recovered and/or towed.

Within FIGS. 2 to 6 the linking bar 710 of the CONP portion of the ATV-TD according to an embodiment of the invention comprises an end rigidly attached to the TAMP portion of the ATV-TD whilst the distal end comprises part of a hitch for attaching the ATV-TD according to an embodiment of the invention to the vehicle towing it. As depicted in first and second images 700A and 700B in FIG. 7 the distal end of the CONP portion of the ATV-TD according to an embodiment of the invention comprises a tube hitch fitting coupled to the linking bar via a joint comprising a first joint which allows motion in a direction perpendicular to the terrain and longitudinal axis of the linking bar, a second joint which allows rotational motion around the longitudinal axis of the linking bar, and a third joint which allows motion in the same axis as the first joint. Accordingly, the linking bar of the CONP is restricted in motion laterally relative to its longitudinal axis but allows for relative vertical motion of the ATV-TD according to an embodiment of the invention relative to the vehicle towing it along the longitudinal axis of the linking bar and relative rotation of the ATV-TD according to an embodiment of the invention relative to the vehicle towing it around the longitudinal axis of the linking bar. Accordingly, as the towing vehicle turns the linking bar acts upon the lower frame of the ATV-TD according to an embodiment of the invention to turn it whilst the upper frame rotational moves relative to the lower frame. Accordingly, the combined assembly of the vehicle towing the ATV-TD and the ATV-TD turn as required to allow navigation from the recovery/loading point to the destination.

However, it would be evident that other linkage designs between the linking arm of the CONP portion of the ATV-TD according to an embodiment of the invention and the TAMP portion of the ATV-TD according to an embodiment of the invention. It would be evident that other couplings at one or both ends of the linking bar may be rigid or flexible within embodiments of the invention. Flexible couplings may be flexible in a single axis, dual axes, three-axes, four-axes, etc. Typically, a four-axis joint is referred to as a universal joint. The previously discussed tube hitch would represent a rigid coupling whereas the ball hitch would allow movement in six axis.

Within the preceding description of an ATV-TD according to an embodiment of the invention in FIGS. 2 to 7 the linking bar is permanently attached to the TAMP portion of the ATV-TD and demountably attached to the vehicle towing the ATV-TD.

However, within another embodiment of the invention the linking bar may be demountably attached to the TAMP portion of the ATV-TD, for example, using another tube hitch. Accordingly, the ATV-TD with a demountable linking bar becomes quite compact allowing it to be transported upon an ATV or another vehicle which will be used to tow/recover an ATV or upon an ATV in case it needs to be towed/recovered. The CONP and TAMP portions of the ATV-TD may therefore be mounted together or separately to an ATV. Optionally, the linking bar of the CONP may have a pair of telescopic sections with a locking mechanism to allow the CONP portion to be “collapsed” for transport/storage and “extended” for use. Additionally, the upper frame of the ATV-TD may be removable detached from the lower frame of the ATV-TD in order to improve the “collapsing” of the ATV-TD for transport, storage, shipping etc.

Within the preceding description of an ATV-TD according to an embodiment of the invention in FIGS. 2 to 7 the linking bar of the CONP portion of the ATV-TD is depicted with a profile that has height reduction (relative to the terrain) at the distal end from the TAMP portion so that it mounts to an ATV towing the ATV-TD from that approximately the same as the top of the lower portion of TAMP. This allows the linking bar to be higher than obstacles such as branches, rocks etc. on the ground. However, within other embodiments of the invention the profile of the linking bar from the TAMP portion of the ATV-TD to its distal end may have different vertical profiles and/or may comprise different lateral profiles rather than the simple linear linking bar depicted. Optionally, the linking bar may be two or more bars linking from the TAMP portion of the ATV-TD according to an embodiment of the invention to the distal end at which they join the mounting point for attachment to the other vehicle towing the ATV-TD. The two or more arms may also comprise one or more bars linking the two or more arms together for additional rigidity/strength etc. For example, the linking bar may have an A-frame geometry consisting of two arms that start from the distal end to the two lateral ends of TAMP portion of the ATV-TD with a cross-linking member between them.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a lower frame portion;
an upper frame portion mechanically coupled to the lower frame and rotatable relative to the lower portion;
at least a pair of wheels attached to the lower frame;
a linking bar at least one of rigidly attached and demountably attached to the lower frame at one end with a first coupling and having a second coupling at the other distal end for demountably attaching the device to a vehicle for towing the device.

2. The device according to claim 1, wherein
the upper frame comprises:
a first frame which is mechanically coupled to the lower frame and rotatable relative to the lower portion; and
a pair of slidable frame members, each slidable frame member mechanically coupled to one end of the first frame and movable relative to the first frame.

3. The device according to claim 2, further comprising
a pair of fittings, each fitting for locking a slidable frame member of the pair of slidable frame members in one position of a plurality of positions with respect to the first frame.

4. The device according to claim 1, wherein
the second coupling comprises:
a first joint mechanically coupled to the linking bar;
a second joint mechanically coupled to the first joint;
a third joint mechanically coupled to the second joint; and
a fitting for coupling to an attachment attached to the vehicle; wherein
the first joint pivots in a plane aligned with a longitudinal axis of the linking bar;
the second joint rotates around the longitudinal axis of the linking bar; and
the third joint pivots in a plane perpendicular to the longitudinal axis of the linking bar.

5. The device according to claim 1, wherein
the height of the first coupling of the linking bar relative to the ground is higher than that the height of the second coupling at the other distal end of the linking bar; and
the linking bar comprises a strut linking the first coupling to the second coupling; wherein
when the device is coupled to the vehicle for towing the device a first portion of the strut from the first coupling to a predetermined point proximal the vehicle is substantially horizontal.

6. A method comprising:
providing a transportation device for moving a first vehicle with a second vehicle;
positioning the transportation device adjacent to a pair of wheels of the first vehicle;
disposing the transportation device in a vertical position with an upper frame of the transportation device adjacent to the pair of wheels of the first vehicle and a linking bar the transportation device pointing substantially perpendicular and upwards relative to the terrain upon which the pair of wheels of the first vehicle are disposed;
attaching the pair of wheels of the first vehicle to the upper frame of the transportation device;
transitioning the transportation device from this vertical position to a horizontal position by using the linking bar as a mechanical lever thereby lifting the pair of wheels of the first vehicle off the ground such that they are supported on the upper platform of the transportation device.

7. The method according to claim 6, wherein
the transportation device comprises:
a lower frame portion;
an upper frame portion mechanically coupled to the lower frame and rotatable relative to the lower portion;
at least a pair of wheels attached to the lower frame;
a linking bar at least one of rigidly attached and demountably attached to the lower frame at one end with a first coupling and having a second coupling at the other distal end for demountably attaching the device to a vehicle for towing the device.

8. The method according to claim 7, wherein
the upper frame comprises:
a first frame which is mechanically coupled to the lower frame and rotatable relative to the lower portion; and
a pair of slidable frame members, each slidable frame member mechanically coupled to one end of the first frame and movable relative to the first frame.

9. The method according to claim 7, wherein
a pair of fittings, each fitting for locking a slidable frame member of the pair of slidable frame members in one position of a plurality of positions with respect to the first frame.

10. The method according to claim 6, wherein
the second coupling comprises:
a first joint mechanically coupled to the linking bar;
a second joint mechanically coupled to the first joint;
a third joint mechanically coupled to the second joint; and
a fitting for coupling to an attachment attached to the vehicle;
the first joint pivots in a plane aligned with a longitudinal axis of the linking bar;
the second joint rotates around the longitudinal axis of the linking bar; and
the third joint pivots in a plane perpendicular to the longitudinal axis of the linking bar.

11. The method according to claim 6, wherein
the height of the first coupling of the linking bar relative to the ground is higher than that the height of the second coupling at the other distal end of the linking bar; and
the linking bar comprises a strut linking the first coupling to the second coupling; wherein
when the device is coupled to the vehicle for towing the device a first portion of the strut from the first coupling to a predetermined point proximal the vehicle is substantially horizontal.
